(19) United States
(12) Patent Application Publication
(10) Pub. No.: US 2005/0008811 A1
(43) Pub. Date: Jan. 13, 2005

(54) Method and apparatus for producing a sheet-like structure

(75) Inventors: Stefan Jung, Munich (DE); Christl Lauterbach, Hohenkirchen-Siegertsbrunn (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/890,523

(22) Filed: Jul. 12, 2004

(30) Foreign Application Priority Data
Jul. 11, 2003 (DE) 103 31 509.8

(51) Int. Cl. B32B 3/02

(52) U.S. Cl. 428/64.2; 428/32.6

(57) ABSTRACT

Method for producing a sheet-like structure using a starting sheet-like structure. The method has a production process with at least one process parameter and includes the steps of arranging at least one information medium on and/or in the starting sheet-like structure, reading data out of the information medium, and adapting the at least one process parameter in a way corresponding to the data read out. Furthermore, an apparatus for producing a sheet-like structure. Also, use of information media for process parameter adaptation in the production of a sheet-like structure.

### CROSS-REFERENCE TO RELATED APPLICATION

This application claims priority to German Patent Application Serial No. 103 31 509.8-16, filed Jul. 11, 2003, and is incorporated herein by reference in its entirety.

### FIELD OF THE INVENTION

The present invention relates to a method and an apparatus for producing a sheet-like structure.

### BACKGROUND OF THE INVENTION

In the production of sheet-like structures, for example laminates, different plastic molding materials are applied to a backing. During production, these plastic molding materials must be heated in heating channels and cooled by cooling rollers. In this respect, the output of the heating channels and cooling rollers is empirically set during the starting up of the machine. The output is in this case set in such a way as to ensure with a high degree of certainty that production proceeds properly. This means that the temperature is generally set higher in the heating channels and lower in the cooling rollers than is actually required. Often, however, such a high output as that which is set is not necessary. This leads to high energy consumption during the production process.

### SUMMARY OF THE INVENTION

It is consequently an object of the present invention to provide a method and an apparatus for producing a sheet-like structure which make energy-saving operation possible.

The invention provides a method for producing a sheet-like structure using a starting sheet-like structure, the method having a production process with at least one process parameter and comprising the following steps:
arranging or applying or introducing at least one information medium on and/or to and/or into the starting sheet-like structure;
reading out the data of the information medium;
adapting or controlling or regulating at least one of the process parameters in a way corresponding to the data read out.

A starting sheet-like structure is in this case a sheet-like structure which is present at the beginning of the production process. This starting sheet-like structure can be worked or processed during the production process. The starting sheet-like structure preferably forms part of the sheet-like structure produced. Alternatively, however, the starting sheet-like structure may also be detached or removed from the end product.

The process parameters are settings or variables of the production process which can be set or changed before and/or during the production process. For example, process parameters may be temperature settings, rates of advancement, etc.

The information media are preferably electronic devices which, as a result of activation by a reading-out or reading device, can transmit data to the reading device or else have new data written to them by means of the reading device.

The information medium preferably comprises at least one sensor integrated in it and the method also comprises a step of measuring process data by the sensor.

The process data are in this case data which are determined during the implementation of the method and preferably relate to the product that is in production. These data preferably provide for example information on the nature and/or the temperature of the sheet-like structure that is in production.

The sensor is preferably a temperature sensor. Alternatively or in addition, a moisture or pressure sensor or a sensor for measuring an electric conductance may also be provided.

The step of reading out the data of the information medium preferably comprises a step of reading out the measured process data.

It is further preferred for the reading-out step to take place contactlessly, i.e. without contact between the information medium and a device for reading out.

The information medium is preferably a transponder, most preferably a radio-frequency identification tag or RF ID tag. The information medium may preferably be a passive transponder, i.e. a transponder which has no energy supply of its own.

The information media are preferably arranged at regular intervals on or in the starting sheet-like structure.

Consequently, in particular the process data can be read out and the process parameters correspondingly adapted preferably at periodic intervals.

The method also preferably comprises a step of storing the process data in the information medium.

The method may also comprise one or more treatment steps, in particular heating, cooling, dyeing, printing, impregnating, coating, washing, drying and/or laminating.

Furthermore, the invention provides an apparatus for producing a sheet-like structure using a starting sheet-like structure, in particular for use in a method according to the invention or a preferred embodiment thereof, comprising:
a device for arranging or applying or introducing at least one information medium on and/or to and/or into the starting sheet-like structure;
a device for reading out the data of the information medium;
a device for adapting or controlling or regulating at least one process parameter in a way corresponding to the data read out.

The device for reading out the data of the information medium is preferably designed for contactless reading out of the data.

The information medium is preferably a transponder, most preferably an RF ID tag, and the device for reading out the data of the information medium is preferably a transponder reading device.

Furthermore, the apparatus may comprise one or more treatment devices, in particular devices for heating, cooling, dyeing, printing, impregnating, coating, washing, drying and/or laminating.

Furthermore, the invention provides the use of information media for process parameter adaptation or regulation or control in the production of a sheet-like structure using a starting sheet-like structure, at least one information medium being arranged on the starting sheet-like structure.

### BRIEF DESCRIPTION OF THE DRAWINGS

Further features, functions and advantages of the present invention become evident from the description which follows of preferred embodiments with reference to the drawings, in which:

FIG. 1 shows an apparatus according to a preferred embodiment of the present invention; and

FIG. 2 shows an information medium used in the apparatus shown in FIG. 1 and an associated reading device.

### DETAILED DESCRIPTION OF THE PREFERRED MODE OF THE INVENTION

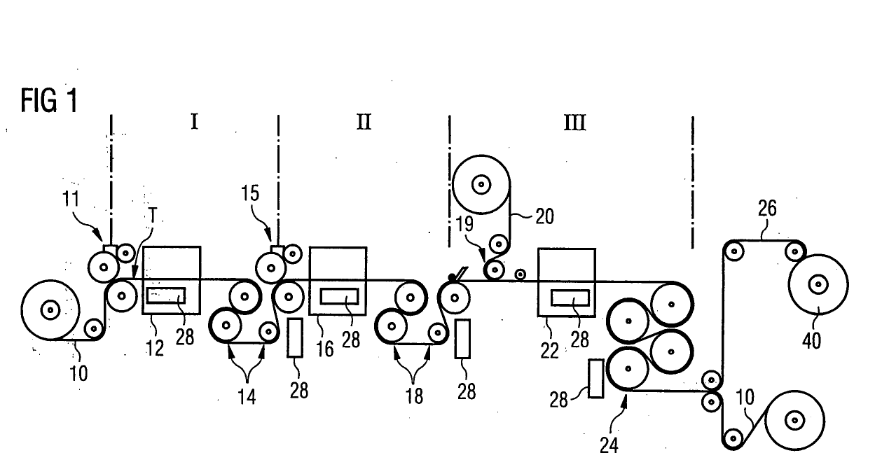

Shown in FIG. 1 is an apparatus according to a preferred embodiment of the present invention which is suitable in particular for producing synthetic leather.

The direction of flow in the apparatus shown in FIG. 1 is from left to right in FIG. 1.

In the region marked by I in FIG. 1, a device 11 for applying a plastic molding material is provided and at the location denoted by the arrow T in FIG. 1 a device (not shown) for arranging information media on or in the layer of plastic is provided. After that, a heating channel 12 and a number of cooling rollers 14 are provided. Preferably at least three information media are arranged in parallel on a wide sheet-like structure, distributed over the entire width (in the middle and at both edge regions), in order to make accurate, temperature control possible over the entire width.

In the region denoted by II in FIG. 1, a device 15 for applying a plastic molding material, a heating channel 16 and cooling rollers 18 are provided in the direction of flow.

In the region denoted by III in FIG. 1, a device 19 for applying a woven fabric backing 20, a heating channel 22 and cooling rollers 24 are provided.

A transponder reader or a reading device 28 is respectively provided in the heating channels 12, 16, 22 and cooling rollers 14, 18, 24 or in their vicinity.

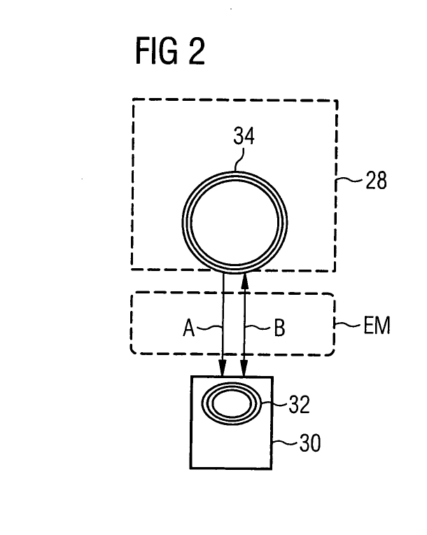

The operating principle of the information media used is described below with reference to FIG. 2. FIG. 2 shows an information medium 30 and an associated reading device or an associated transponder reader 28, which are used in the preferred embodiment of the invention.

The information media 30 are preferably formed as radio-frequency identification tags or RF ID tags 30. The RF ID tag 30 comprises a coil 32, which can be activated by electromagnetic waves. In order to activate the RF ID tag 30, a reading device 28 which likewise comprises a coil 34 is used. The RF ID tag 30 is preferably a passive transponder, which requires no energy supply of its own.

For reading out the information stored on the RF ID tag 30, the reading device 28 builds up an electromagnetic field (identified in FIG. 2 by EM). If the RF ID tag 30 comes into the electromagnetic field or reading field, it influences the reading field in such a way that the reader can read out the information stored on the RF ID tag 30 or the sensor data. The transmission of the data consequently takes place contactlessly. The transmitted information is picked up by the reading device 28, decoded and further processed appropriately.

Furthermore, it may be provided that the reading device 28 is formed as a reading and writing device and, in addition to the reading out of data, can also write data to the information medium. Consequently, in addition to the straightforward reading of the data of the information media, data can also be stored on the information media.

The distance between the RF ID tag 30 and the reading device 28 at which the RF ID tag 30 is activated may vary depending on the area of use. Generally, the value of this distance lies in the range from about 5 cm to about 1 m.

In the preferred embodiment described, the RF ID tag 30 comprises a sensor such as for example a temperature sensor or moisture sensor.

For the temperature sensor, it is possible for example to use the temperature-dependent voltage drop across an integrated silicon resistor in comparison with a bandgap reference voltage.

The operation of the apparatus described above is described below.

In the region marked by I in FIG. 1, a plastic molding material, known as a top coat, is firstly applied by the device 11 to a paper backing 10, in which the desired surface structure has been impressed. After that, RF ID tags 30 are introduced into the plastic molding material, or attached or arranged on it, at the location identified by the arrow T. RF ID tags 30 are preferably introduced into the plastic molding material at periodic intervals. In the embodiment described, the top coat consequently forms the starting sheet-like structure.

In the heating channel 12, the layer of plastic is activated and a polymerization takes place. After that, the layer is cooled as it passes through cooling rollers 14.

In the region denoted in FIG. 1 by II, after that a further application of a plastic molding material takes place by device 15, the so-called foam coating. This foam coating is activated in the heating channel 16 and cooled by cooling rollers 18.

After that, a supporting woven fabric backing 20 is laminated on with a hot-melt adhesive in the region denoted in FIG. 1 by III. In the heating channel 22 the laminate is firmly bonded and cooled by cooling rollers 24.

After that, the paper backing 10 can be pulled off and the finished sheet-like structure or synthetic leather 26 can be rolled up onto a roll 40.

As it passes through the heating channels 12, 16, 22 and the cooling rollers 14, 18, 24, the temperature and/or moisture in the sheet-like structure can be determined with the aid of the RF ID tags 30 arranged in or on the sheet-like structure that is in production.

These data are read out by transponder readers 28. In dependence on the measured temperature, the temperature of the heating channels 12, 16, 22 and cooling rollers 14, 18, 24 can be correspondingly adapted, i.e. raised or lowered, by the respective regulating or controlling devices (not shown).

This can achieve the effect that in every stage of the process there is always a virtually optimum temperature, required for the respective process step. The periodic arrangement of the RF ID tags 30 allows this adaptation to be carried out with great accuracy. The setting of unnecessarily high or low temperature values can be avoided. Since the temperature can be optimally set, the energy consumption can be lowered.

The RF ID tags 30 preferably remain in the sheet-like structure and can be used thereafter, preferably when the sheet-like structure is being put to its intended use, for example for logistical purposes during the production process or during sales, for temperature monitoring, regulating the air-conditioning system and/or monitoring the humidity in rooms.

In particular, the method described above can be used with preference in the following areas:

In the case of carpet manufacture, transponders can be introduced onto a woven fabric backing and used for monitoring the moisture during dyeing, washing and drying and for monitoring the temperature during lining with the woven fabric backing.

Furthermore, the method can be used in the manufacture of sheet-like industrial textiles, for example awnings, tarpaulins, synthetic leather, for monitoring the temperature during lining and laminating processes or during dyeing, washing and drying processes, and also during the surface finishing and impregnation of fabrics for clothing and interior design textiles or textiles in automobile construction. Furthermore, the method according to the invention can be used in the manufacture of film-based floor and wall coverings without textile components.

The method according to the invention is used with preference in production processes with temperature cycles. It is further preferred that the method can be used in the manufacture of any desired laminates.

1. A method for producing a sheet-like structure using a starting sheet-like structure, the method having a production process with at least one process parameter and comprising the steps of:
arranging at least one information medium on and/or in the starting sheet-like structure;
reading data out of the information medium; and
adapting the at least one process parameter in a way corresponding to the data read out.

2. The method as claimed in claim 1, wherein the information medium comprises at least one sensor integrated therein, and the method further comprises the step of using the at least one sensor to measure process data.

3. The method as claimed in claim 2, wherein the sensor is a temperature sensor.

4. The method as claimed in claim 2, wherein the sensor is a moisture sensor.

5. The method as claimed in claim 2, wherein the step of reading data out of the information medium comprises a step of reading out the measured process data.

6. The method as claimed in claim 2, further comprising a step of storing the measured process data in the information medium.

7. The method as claimed in claim 1, wherein the reading step is performed contactlessly.

8. The method as claimed in claim 1, wherein the information medium is a transponder.

9. The method as claimed in claim 1, wherein the information media is arranged at regular intervals on the starting sheet-like structure.

10. The method as claimed in claim 1, further comprising one or more heating, cooling, dyeing, printing, impregnating, coating, washing, drying and/or laminating steps.

11. An apparatus for producing a sheet-like structure using a starting sheet-like structure for use in a method as claimed in claim 1, comprising:
an arranging device that arranges at least one information medium on and/or in the starting sheet-like structure;
a reading device that reads data out of the information medium; and
an adapting device that adapts at least one process parameter in a way that corresponds to the data read out.

12. The apparatus as claimed in claim 11, wherein the reading device is designed to read out the data contactlessly.

13. The apparatus as claimed in claim 11, wherein the information medium is a transponder, and the reading device is a transponder reading device.

14. The apparatus as claimed in claim 11, further comprising one or more heating, cooling, dyeing, printing, impregnating, coating, washing, drying and/or laminating devices.

15. A use of information media for process parameter adaptation in a production of a sheet-like structure using a starting sheet-like structure, wherein at least one information medium is arranged on the starting sheet-like structure.
